(19) United States
(12) Patent Application Publication
(10) Pub. No.: US 2004/0032813 A1
(43) Pub. Date: Feb. 19, 2004

(54) Optical disc having plurality of recording layers, recording method and reproducing method therefor

(75) Inventors: Kyung-geun Lee, Gyeonggi-do (KR); Yong-Jin Ahn, Seoul (KR); In-alk Park, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/453,928

(22) Filed: Jun. 4, 2003

Related U.S. Application Data
(60) Provisional application No. 60/385,553, filed on Jun. 5, 2002.

(30) Foreign Application Priority Data
Jun. 5, 2002 (KR) 2002-31613

(51) Int. Cl. G11B 7/24

(52) U.S. Cl. 369/94; 369/52.1; 369/275.3

(57) ABSTRACT

An optical disc includes a plurality of recording layers. Each of recording layers includes a lead-in area, a data area, and a lead-out area. At least one of the recording layers has a burst cutting area (BCA) area on which unique disc information is recorded, and at least one of the lead-in area and the lead-out area includes a dedicated reproducing area having a BCA pointer zone in which pointer information on the BCA area is recorded. Accordingly, reliability of recording and/or reproducing data with respect to the disc is improved.

### CROSS-REFERENCE TO RELATED APPLICATIONS

This application claims the benefit of Korean Application No. 2002-31613, filed Jun. 5, 2002, in the Korean Intellectual Property Office, and U.S. Provisional Application No. 60/385,553, filed Jun. 5, 2002, the disclosures of which are incorporated herein by reference.

### BACKGROUND OF THE INVENTION

1. Field of the Invention

The present invention relates to an optical disc, and more particularly, to an optical disc having a plurality of recording layers and a recording method and reproducing method thereof.

2. Description of the Related Art

Generally, optical discs such as CDs and DVDs are representative of information storage media that are widely used at the present time. However, as production and distribution of digital contents requiring relatively a large amount of data, such as audio/video (AV) data, increase, an optical disc having a higher recording capacity than that of conventional CDs and DVDs is needed for the digital content recording.

To increase the recording capacity of an optical disc, two or more recording layers may be formed to record user data in the optical disc. However, with a plurality of recording layers, maintaining a reliable recording and/or reproducing is more difficult. That is, compared to an optical disc having a single recording layer, to read information recorded on each recording layer, a laser beam has to be controlled more precisely with an optical disc having a plurality of recording layers. Additionally, a reading error may occur more frequently with the optical disc having a plurality of recording layers, where a disc surface thereof is obstructed and/or damaged.

For example, an optical disc includes a burst cutting area (BCA) zone in which unique information of the disc, that is, the serial number, the manufacturing date, etc., are recorded. To read information from or record information on the optical disc, the unique disc information recorded in the BCA zone should be correctly read and sent to a drive for controlling an optical pickup of a recording/reproducing apparatus. However, as described above, with two or more recording layers, it is difficult to correctly read the unique disc information.

### SUMMARY OF THE INVENTION

Accordingly, it is an aspect of the present invention to provide an optical disc having a data structure in which unique disc information can be more reliably read so as to reliably record and/or reproduce data, and a recording method and reproducing method thereof.

Additional aspects and advantages of the invention will be set forth in part in the description which follows and, in part, will be obvious from the description, or may be learned by practice of the invention.

To achieve the above and/or other aspects of the present invention, there is provided an optical disc comprising recording layers, wherein each of the recording layers includes a lead-in area, a data area, and a lead-out area, at least one of the recording layers further includes a burst cutting area (BCA) area having unique disc information, and at least one of the lead-in and lead-out areas includes a dedicated reproducing area having a BCA pointer zone including pointer information on the BCA area.

The BCA pointer zone may be formed in the lead-in area or the lead-out area of one of the recording layers having the BCA area, and the pointer information may include information on presence of the BCA area and a recording location of the BCA area.

To achieve the above and/or other aspects of the present invention, there is provided another optical disc comprising a first recording layer having a first lead-in area, a first data area, and a first lead-out area, and a second recording layer having a second lead-in area, a second data area, and a second lead-out area, wherein at least one of the first recording layer and the second recording layer includes a BCA area having unique disc information, and at least one of the first lead-in area and the second lead-in area includes a dedicated reproducing area having a BCA pointer zone including pointer information on the BCA area.

The BCA pointer zone may formed on the first or second recording layer having the BCA area, and the pointer information may include information on presence of the BCA area and a recording location of the BCA area.

To achieve the above and/or other aspects of the present invention, there is provided a method of recording user data on and/or reproducing the user data from an optical disc having recording layers, the method comprising reading BCA pointer information from a BCA pointer zone formed in one of an inner circumference and an outer circumference of a predetermined one of the recording layers of the disc, in response to the BCA pointer information not being normally read, reading the BCA pointer information from a second BCA pointer zone formed in another one of the recording layers, at an inner/outer circumference thereof which is opposite to that of the BCA pointer zone provided in the predetermined recording layer, and reading the user data on and/or reproducing the user data from the optical disc according to the read BCA pointer information.

### BRIEF DESCRIPTION OF THE DRAWINGS

These and/or other aspects and advantages of the invention will become apparent and more readily appreciated from the following description of the preferred embodiments taken in conjunction with the accompanying drawings in which:

FIG. 1 is a schematic diagram of an optical disc according to an embodiment of the present invention;

FIG. 2 is a reference diagram illustrating a direction of recording data on and/or reproducing the data from the optical disc of FIG. 1;

FIG. 3 is a schematic diagram of an optical disc according to another embodiment of the present invention;

FIG. 4 is a reference diagram illustrating a direction of recording data on and/or reproducing the data from the optical disc of FIG. 3;

FIG. 5 is a schematic diagram of an optical disc according to yet another embodiment of the present invention;

FIG. 6 is a reference diagram illustrating a direction of recording data on and/or reproducing the data from the optical disc of FIG. 5;

FIG. 7 is a diagram of the data structure of a lead-in/out area according to the present invention;

FIG. 8 is a diagram of a data structure in a dedicated reproducing area on which burst cutting area (BCA) pointer information according to the present invention is recorded;

FIG. 9 is a diagram of a first example of a dedicated reproducing area and a rewritable area;

FIG. 10 is a diagram of a second example of a dedicated reproducing area and a rewritable area;

FIG. 11 is a diagram of a third example of a dedicated reproducing area and a rewritable area;

FIG. 12 is a diagram of a fourth example of a dedicated reproducing area and a rewritable area;

FIGS. 13A-13B, 14A-14C, and 15-17 are reference diagrams illustrating a method of modulating a wobble signal; and

FIG. 18 is a flowchart illustrating a recording/reproducing method according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

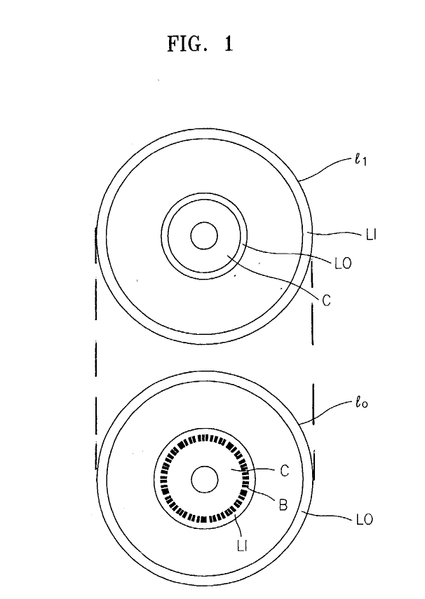

FIG. 1 shows an optical disc according to an embodiment of the present invention. Referring to FIG. 1, the optical disc includes a first recording layer l0 and a second recording layer l1. A space layer (not shown), which physically separates the recording layers l0 and l1, is provided between the recording layers l0 and l1. In the present embodiment, the thickness of a substrate (not shown) of a light incident surface is 0.6 mm or 0.1 mm.

Each of the first recording layer l0 and the second recording layer l1 includes a clamping area C, a lead-in area LI, and a lead-out area LO. The clamping area C is a region on which a pressure is applied by a clamping device (not shown) to clamp the disc. Generally, the clamping area C has a ring shape at a center of an inner circumference of the disc. A data area, on which user data is recorded, is provided between the lead-in area LI and the lead-out area LO. A burst cutting area (BCA) area B is formed between the clamping area C and the lead-in area LI of the first recording layer l0. On the BCA area B, unique information of the disc is recorded. The unique information of the disc may include the serial number and the manufacturing date. Where the first recording layer l0 is formed as a phase-changing film, the unique disc information is recorded as a mark pattern in which crystalline and/or non-crystalline marks are arranged. More detailed information on a method of recording unique disc information in a BCA area is described in Korean Patent Application No. 2001-47957, “Optical disc, a method for recording unique information of an optical disc, and a reproducing method thereof” filed by the applicant of the present invention.

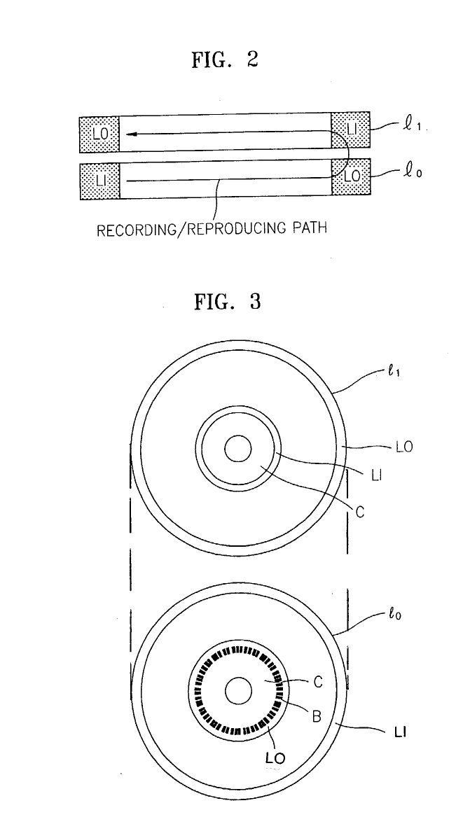

FIG. 2 shows a reference diagram illustrating a direction of recording data on and/or reproducing the data from the optical disc of FIG. 1. Referring to FIG. 2, shaded areas are the lead-in areas LI and the lead-out areas LO, and remaining areas are data areas on which user data is recorded.

For example, it is assumed that recording and/or reproducing data is performed from an inner circumference to an outer circumference of a disc by rotating the disc counterclockwise where the disc is seen from a light source of a laser beam. A recording/reproducing path of the optical disc of FIG. 1 follows an opposite track path (OTP) method in which a path begins in the lead-in area LI of the first recording layer l0, extends through the lead-out area LO of the first recording layer l0, and the lead-in area LI of the second recording layer l1, and ends in the lead-out LO area of the second recording layer l1. That is, a lead-in area in the present invention refers to an area where the recording/reproducing begins in the recording layer of the lead-in area, and a lead-out area refers to an area where the recording/reproducing ends in the recording layer of the lead-out area. Accordingly, the lead-in LI area or the lead-out area LO may be formed on the outer circumference or inner circumference of the disc. In the present embodiment, the lead-in area LI of the first recording layer l0 is formed on the inner circumference of the disc, and the lead-out area LO is formed on the outer circumference of the disc, while the lead-in area LI of the second recording layer l1 is formed on the outer circumference of the disc, and the lead-out area LO is formed on the inner circumference.

FIG. 3 shows an optical disc according to another embodiment of the present invention. The optical disc includes a first recording layer l0 and a second recording layer l1. Each of the first recording layer l0 and the second recording layer l1 includes a clamping area C, a lead-in area LI, and a lead-out area LO. The clamping area C is a region on which a pressure is applied by a clamping device (not shown) to clamp the disc. Generally, the clamping area C has a ring shape at a center of an inner circumference of the disc. A data area, on which user data is recorded, is provided between the lead-in area LI and the lead-out area LO. A burst cutting area (BCA) area B is formed between the clamping area C and the lead-in area LI of the first recording layer l0. On the BCA area B, unique information of the disc is recorded. The unique information of a disc includes the serial number and the manufacturing date. Where the first recording layer l0 is formed as a phase-changing film, the unique disc information is recorded as a mark pattern in which crystalline and/or non-crystalline marks are arranged. More detailed information on a method of recording unique disc information in a BCA area is described in Korean Patent Application No. 2001-47957, “Optical disc, a method for recording unique information of an optical disc, and a reproducing method thereof” filed by the applicant of the present invention.

Compared to the optical disc of FIG. 1, the optical disc of FIG. 3 has the lead-in areas and the lead-out areas arranged in the opposite direction. That is, in the embodiment of FIG. 3, the lead-in area LI of the first recording layer l0 is formed on the outer circumference of the disc, and the lead-out area LO is formed on the inner circumference of the disc, while the lead-in area of the second recording layer l1 is formed on the inner circumference of the disc, and the lead-out area is formed on the outer circumference.

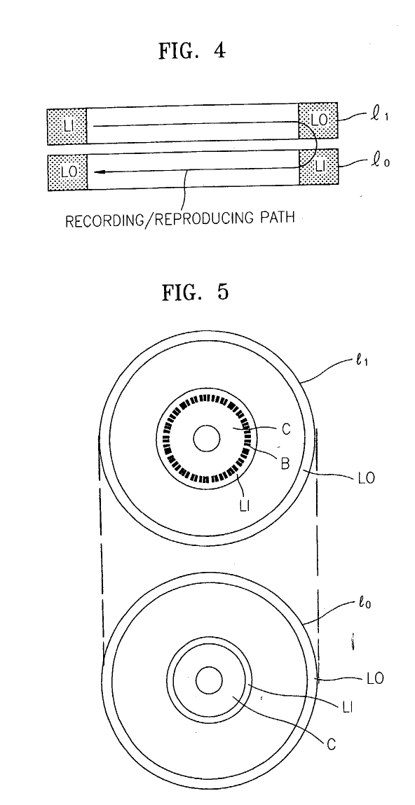

FIG. 4 shows a reference diagram illustrating a direction of recording data on and/or reproducing the data from the optical disc of FIG. 3. Referring to FIG. 4, shaded areas are the lead-in areas LI and the lead-out areas LO, and the remaining areas are data areas on which user data is recorded.

For example, it is assumed that recording and/or reproducing data is performed from an inner circumference to an outer circumference of a disc by rotating the disc counterclockwise where the disc is seen from a light source of a laser beam. A recording/reproducing path of the optical disc of FIG. 3 follows an opposite track path (OTP) method in which a path begins in the lead-in area LI of the second recording layer l1, extends through the lead-out area LO of the second recording layer l1, and the lead-in area LI of the first recording layer l0, and ends in the lead-out area LO of the first recording layer l0.

FIG. 5 shows an optical disc according to yet another embodiment of the present invention. The optical disc includes a first recording layer l0 and a second recording layer l1. Each of the first recording layer l0 and the second recording layer l1 includes a clamping area C, a lead-in area LI, and a lead-out area LO. The clamping area C is a region on which a pressure is applied by a clamping device (not shown) to clamp the disc. Generally, the clamping area C has a ring shape at a center of an inner circumference of the disc. A data area, on which user data is recorded, is provided between the lead-in area LI and the lead-out area LO. A burst cutting area (BCA) area B is formed between the clamping area C and the lead-in area LI of the second recording layer l1. On the BCA area B, unique information of the disc is recorded. The unique information of the disc includes the serial number and the manufacturing date. Where the second recording layer l1 is formed as a phase-changing film, the unique disc information is recorded as a mark pattern in which crystalline and/or non-crystalline marks are arranged. More detailed information on a method of recording unique disc information in a BCA area is described in Korean Patent Application No. 2001-47957, “Optical disc, a method for recording unique information of an optical disc, and a reproducing method thereof” filed by the applicant of the present invention.

Compared to the optical disc of FIG. 1, the optical disc of FIG. 5 has the BCA area B in a different region. That is, in the embodiment of FIG. 5, the BCA area is formed on the second recording layer l1.

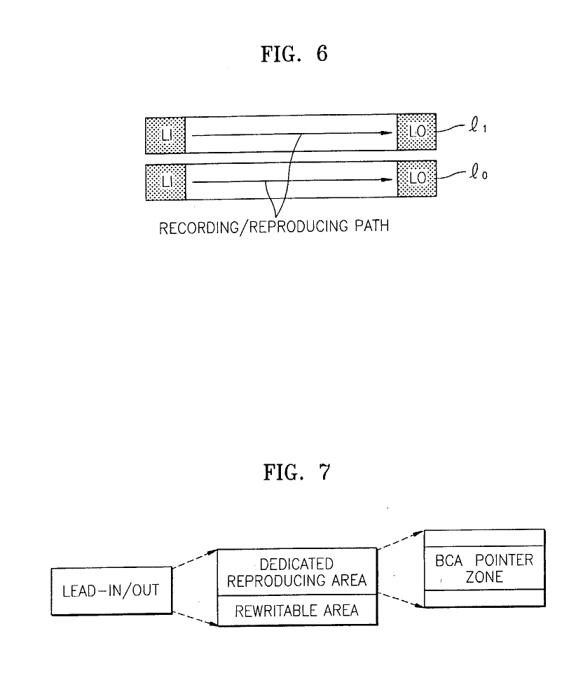

FIG. 6 shows a reference diagram illustrating a direction of recording data on and/or reproducing data from the optical disc of FIG. 5.

Referring to FIG. 6, shaded areas are the lead-in areas LI and the lead-out areas LO, and the remaining areas are data areas on which user data is recorded. A recording/reproducing path of the optical disc of FIG. 5 follows a parallel track path (PTP) method in which a path begins in the lead-in area LI of one of the first recording layer l0 and the second recording layer l1, extends through the lead-out area LO of the one recording layer, and the lead-in area LI of the other recording layer, and ends in the lead-out area LO of the other recording layer.

FIG. 7 shows a data structure of a lead-in/out area according to the present invention. The lead-in/out area comprises a dedicated reproducing area and a rewritable area. The dedicated reproducing area is an area on which dedicated reproducing data which, once recorded, are not deleted, are recorded. The rewritable area is an area on which rewritable data that are for user data and are newly recorded on a data area, are recorded.

The dedicated reproducing area according to the present invention includes a BCA pointer zone. In the BCA pointer zone, pointer information on a BCA area is recorded. In the present embodiment, the BCA pointer information comprises information on whether or not there is a BCA area, and, where there is a BCA area, information on a location of the BCA area.

The dedicated reproducing area may further include disc-related information. For example, the disc-related information may include a reference code to adjust an optical pickup, for example, a location of a focal point. The disc-related information may further include control data such as the type of the disc, the size of the disc, the version number, the recording density, the number of recording layers, and sector numbers indicating data areas of the disc.

The rewritable area may comprise a test zone, a disc control data zone, and a defect management zone. The test zone includes a disc test zone and/or a drive test zone. For example, the disc test zone and drive test zone are utilized to test a recording pulse. In the disc control data zone, control data on user data that are newly recorded in a data area are recorded.

In the disc control data zone, a variety of control data may be recorded. In the present embodiment, the disc control data zone comprises a plurality of areas on which predetermined control data are recorded, and reserved areas for future use. An example of control data is drive information. The drive information is information on a drive which is used in recording data, and includes manufacturer information and an identifier.

Where the lead-in/out area of a predetermined recording layer has the above-described structure, the lead-out/in area of the same recording layer has only a defective management zone and a buffer zone. The purpose of defective zone is the same as described above, and the buffer zone indicates a kind of a transition area, that is, a boundary of a predetermined area or a boundary between areas.

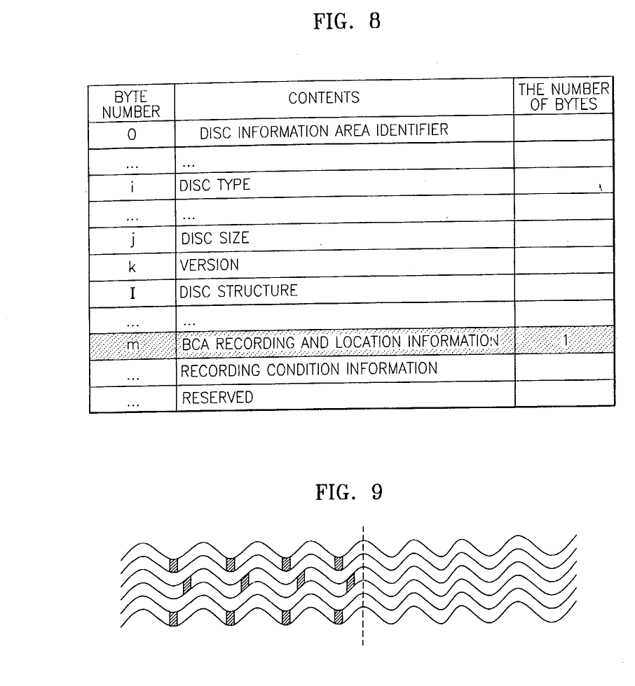

FIG. 8 shows an embodiment of a data structure in a dedicated reproducing area according to the present invention. The dedicated reproducing area includes information on whether or not there is a BCA area and BCA pointer information which is information on a location of the BCA area. The dedicated reproducing area further includes disc-related information having disc type information which indicates whether the disc is a rewritable disc, a write-once disc, or a dedicated reproducing disc, disc size information which is expressed with regards to the diameter of the disc, a version number, disc structure information which indicates the number of recording layers, and a power and time condition for a recording/reproducing operation.

In the present embodiment, pointer information is recorded using an m-th byte. For example, in the m-th byte, the first 4 bits refer to recording location information and the remaining 4 bits refer to information on presence of a BCA area. Where the first 4 bits indicate a layer on which a BCA area is located, the 4 bits can be defined as follows:

0000b: the first recording layer l0

0001b: the second recording layer l1

0010b: the first recording layer l0 and the second recording layer l1

Others: Reserved

The remaining 4 bits can be defined as follows:

0000b: There is no BCA area

0001b: There is a BCA area

For example, where there is a BCA area in the first recording layer l0 and there is no BCA area in the second recording layer l1, m-th byte can be expressed as follows:

00000001b

Where the number of the recording layers exceed 2, or it is difficult to express BCA pointer information with 1 byte for other reasons (i.e., the number of bits is short), other byte(s) may be used.

An example of forming a dedicated reproducing area and a rewritable area containing a BCA area having the data structure described above will now be explained.

FIG. 9 shows a first example of a dedicated reproducing area and a rewritable area. As shown in FIG. 9, the dedicated reproducing area and the rewritable area are formed as wobble tracks. Here, data on the dedicated reproducing area are recorded as land pre-pits, and data on the rewritable area are loaded on a wobble signal and then recorded.

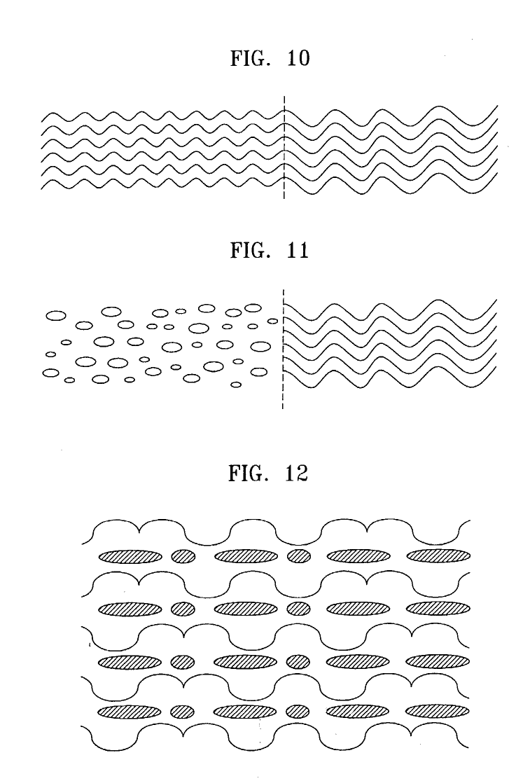

FIG. 10 shows a second example of a dedicated reproducing area and a rewritable area. As shown in FIG. 10, the dedicated reproducing area is formed as a high frequency wobble track on which a high frequency wobble signal is recorded, and the rewritable area is formed as a low frequency wobble track, as compared to that of, for example, the high frequency wobble track of the dedicated reproducing area, on which a low frequency wobble signal is recorded.

In FIGS. 9 and 10, since both the dedicated reproducing area and rewritable area are formed as wobble tracks similar to that of a data area, physical shapes are uniform on the entire disc. Accordingly, even where the disc has two or more recording layers, a good reproducing characteristic is obtained.

FIG. 11 shows a third example of a dedicated reproducing area and a rewritable area. As shown in FIG. 11, the dedicated reproducing area is formed as a pre-pit area on which data are recorded as pre-pits, and the rewritable area is formed as a wobble track on which a wobble signal having corresponding data is recorded. Since the rewritable area is also formed as a wobble track similar to that of a data area, the areas have a more uniform physical shape. Accordingly, even where the disc has two or more recording layers, a good reproducing characteristic is obtained.

FIG. 12 shows a fourth example of a dedicated reproducing area and a rewritable area. As shown in FIG. 12, the dedicated reproducing area is formed as a wobble track on which a wobble signal having corresponding data is recorded, and the data corresponding to the rewritable area is recorded as recording marks in the wobble track of the dedicated reproducing area. Since in one area, the data of the dedicated reproducing area is recorded as a wobble signal, and the data of the rewritable area is recorded as recording marks, the data area in which user data are recorded becomes relatively wider. Accordingly, the structure of this embodiment is advantageous in terms of increasing a recording capacity of the disc.

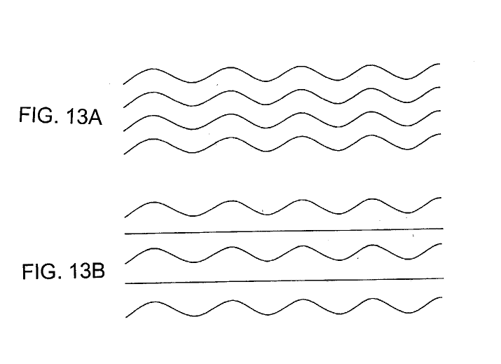

The wobble track described above may have wobbles formed on both side walls of a groove and a land, as shown in FIG. 13A, or may have wobbles formed on only one side wall of a land or groove, as shown in FIG. 13B.

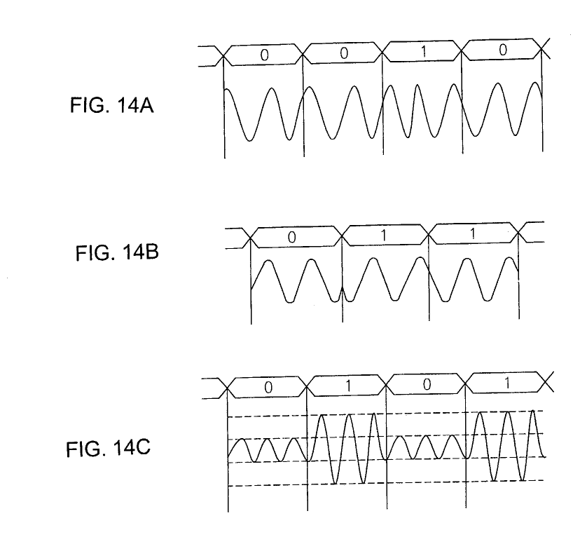

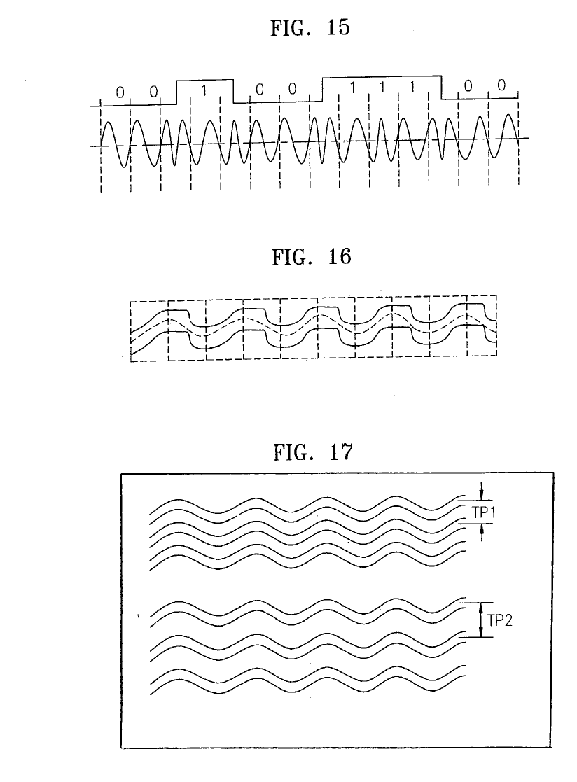

For example, in a wobble signal read from a wobble track, data is loaded after being modulated by the following method. FIG. 14A shows a frequency modulation method. In this method, a data bit having a logic value “0” is made to have a frequency different from the frequency of a data bit having a logic value “1”. By doing so, data bits are recorded. FIG. 14B shows a phase modulation method. Here, a data bit having a logic value “0” is made to have a phase of a wobble signal which is different from the phase of a wobble signal of a data bit having a logic value “1”, and thus, data bits are recorded. FIG. 14C shows an amplitude modulation method. Here, a data bit having a logic value “0” is made to have an amplitude of a wobble signal which is different from the amplitude of a wobble signal of a data bit having a logic value “1”, and thus, data bits are recorded. FIG. 15 shows a minimum shift keying (MSK) method in which only the frequency of a partial interval of a continuous wobble signal changes. FIG. 16 shows a saw tooth wobble (STW) method in which a wobble signal having a saw tooth shape is recorded. In the saw tooth wobble signal, a logic value is determined as “0” or “1” according to a slope direction of the saw tooth. In addition, as shown in FIG. 17, by forming different track pitches (TP1, TP2) of wobble tracks on which a wobble signal is recorded, crosstalk between tracks can be reduced.

Based on the structure described above, a recording/reproducing method according to the present invention will now be explained.

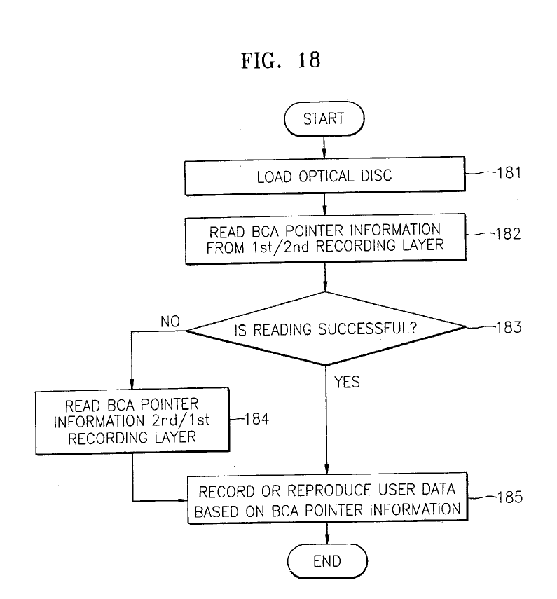

FIG. 18 shows a flowchart illustrating a recording/reproducing method according to an embodiment of the present invention. Referring to FIG. 18, an optical disc is loaded on a recording/reproducing apparatus in operation 181. An optical pickup of the recording/reproducing apparatus reads BCA pointer information from a BCA pointer zone in one of the first recording layer l0 and the second recording layer l1 in operation 182. Where the BCA pointer information is not normally reproduced in operation 183, the optical pickup of the recording/reproducing apparatus reads the BCA pointer information from a BCA pointer zone in the other layer of the first recording layer l0 and the second recording layer l1 in operation 184. Based on the BCA pointer information, the recording/reproducing apparatus records user data in a data area or reproduces the user data recorded in the data area in operation 185. That is, the read BCA pointer information is provided to a drive of the optical pickup in the recording/reproducing apparatus, and based on the provided BCA pointer information, the drive controls the optical pickup so as to record/reproduce the user data on/from the optical disc.

Where the BCA pointer information is normally reproduced without error in the operation 183, based on the information, the user data is recorded on or reproduced from the optical disc in the operation 185.

For the method of FIG. 18, it is assumed that at least two or more recording layers include the BCA pointer zone according to the present invention, and two or more BCA pointer zones are located in different area of respective recording layers. For example, the BCA pointer zone of the first recording layer is located on an inner circumference of the disc, while the BCA pointer zone of the second recording layer is located on an outer circumference of the disc. That is, where reading BCA pointer information from a BCA pointer zone in a predetermined recording layer fails due to dust on a surface of the disc, BCA pointer information can be read from another location of the other recording layer.

As described above, according to the present invention, BCA pointer information can be reliably read, and accordingly, recording/reproducing characteristics are improved even in an optical disc having two or more recording layers.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical disc comprising recording layers, wherein:
each of recording layers includes a lead-in area, a data area, and a lead-out area,
at least one of the recording layers further includes a burst cutting area (BCA) area having unique disc information, and
at least one of the lead-in and lead-out areas includes a dedicated reproducing area having a BCA pointer zone including pointer information on the BCA area.

2. The optical disc of claim 1, wherein at least one of the lead-in and lead-out areas further includes a rewritable area to reproduce user data which is recorded on the data area.

3. The optical disc of claim 1, wherein the BCA pointer zone is formed in the lead-in area or the lead-out area of one of the recording layers having the BCA area.

4. The optical disc of claim 1, wherein the pointer information includes information on presence of the BCA area and a recording location of the BCA area.

5. The optical disc of claim 4, wherein the pointer information is recorded by using 1 byte, first 4 bits thereof indicate the recording location information and the remaining 4 bits thereof indicate the presence of the BCA area.

6. An optical disc comprising:
a first recording layer having a first lead-in area, a first data area, and a first lead-out area; and
a second recording layer having a second lead-in area, a second data area, and a second lead-out area, wherein:
at least one of the first recording layer and the second recording layer includes a BCA area having unique disc information, and
at least one of the first lead-in area and the second lead-in area includes a dedicated reproducing area having a BCA pointer zone including pointer information on the BCA area.

7. The optical disc of claim 6, wherein at least one of the first and second lead-in areas and the first and second lead-out areas includes a rewritable area to reproduce user data which is recorded on a corresponding one of the first and second data areas.

8. The optical disc of claim 6, wherein the BCA pointer zone is formed on the first or second recording layer having the BCA area.

9. The optical disc of claim 6, wherein the BCA pointer zone is formed on each of the first recording layer and the second recording layer.

10. The optical disc of claim 6, wherein the pointer information includes information on presence of the BCA area and a recording location of the BCA area.

11. The optical disc of claim 10, wherein the pointer information is recorded by using 1 byte, first 4 bits thereof indicate the recording location information and the remaining 4 bits thereof indicate the presence of the BCA area.

12. The optical disc of claim 11, wherein the first 4 bits being “0000” indicates the first recording layer, the first 4 bits being “0001” indicates the second recording layer, and the first 4 bits being “0010” indicates both the first recording layer and second recording layer.

13. The optical disc of claim 12, wherein the remaining 4 bits being “0000” indicates that the BCA area does not exist, and the remaining 4 bits being “0001” indicates that the BCA area exists.

14. The optical disc of claim 7, wherein:
the dedicated reproducing area is formed as wobble tracks on which corresponding data are recorded as land pre-pits, and the rewritable area is formed as wobble tracks on which a wobble signal having corresponding data is recorded.

15. The optical disc of claim 7, wherein:
the dedicated reproducing area is formed as high frequency wobble tracks on which a high frequency wobble signal having corresponding data is recorded, and the rewritable area is formed as low frequency wobble tracks on which a low frequency wobble signal having corresponding data is recorded.

16. The optical disc of claim 7, wherein:
the dedicated reproducing area is formed as a pre-pit area on which corresponding data are recorded as pre-pits, and
the rewritable area is formed as wobble tracks on which a wobble signal having corresponding data is recorded.

17. The optical disc of claim 7, wherein:
the dedicated reproducing area is formed as wobble tracks on which a wobble signal having corresponding data is recorded, and
data corresponding to the rewritable area are recorded as recording marks on the wobble tracks of the dedicated reproducing area.

18. The optical disc of claim 14, wherein the data contained in the wobble signal are formed after being modulated by one of a frequency modulation, an amplitude modulation, a phase modulation, a minimum shift keying and a saw tooth modulation.

19. A method of recording user data on and/or reproducing the user data from an optical disc having recording layers, the method comprising:
reading BCA pointer information from a BCA pointer zone formed in one of an inner circumference and an outer circumference of a predetermined one of the recording layers;
in response to the BCA pointer information not being normally read, reading the BCA pointer information from a second BCA pointer zone formed in another one of the recording layers, at an inner/outer circumference thereof which is opposite to that of the BCA pointer zone provided in the predetermined recording layer; and
reading the user data on and/or reproducing the user data from the optical disc according to the read BCA pointer information.

20. The method of claim 19, wherein the reading of BCA pointer information includes:
providing the BCA pointer information to a drive of a recording/reproducing apparatus for the optical disc; and
recording the user data on or reproducing the user data from the optical disc by controlling the drive based on the provided BCA pointer information.

21. The optical disc of claim 1, wherein the optical disc follows an opposite track path as a recording/reproducing path of the optical disc.

22. The optical disc of claim 1, wherein the optical disc follows a parallel track path as a recording/reproducing path of the optical disc.

23. The optical disc of claim 1, wherein the unique optical disc information includes a serial number and a manufacture date of the optical disc.

24. The optical disc of claim 1, wherein the dedicated reproducing area further includes disc-related information.

25. The optical disc of claim 1, wherein each of the recording layers includes the BCA pointer zone at different areas thereof.

26. The optical disc of claim 2, wherein the rewriteable area includes a test zone, a disc control data zone and a defect management zone.

27. The optical disc of claim 6, wherein:
the first lead-in area and the second lead-out area are provided at an inner circumference of the optical disc, and
the first lead-out area and the second lead-in area are provided at an outer circumference of the optical disc.

28. The optical disc of claim 6, wherein:
the first lead-out area and the second lead-in area are provided at an inner circumference of the optical disc, and
the first lead-in area and the second lead-out area are provided at an outer circumference of the optical disc.

29. The optical disc of claim 6, wherein:
the first lead-in area and the second lead-in area are provided at an inner circumference of the optical disc, and
the first lead-out area and the second lead-out area are provided at an outer circumference of the optical disc.

30. The optical disc of claim 14, wherein the wobble tracks have different track pitches so as to reduce crosstalk between tracks of the optical disc.

31. A storage medium comprising:
recording layers;
a burst cutting area (BCA) area which is provided in at least one of the recording layers and includes unique disc information; and
a dedicated reproducing area which is provided in at least one of lead-in and lead-out areas of the storage medium and includes a BCA pointer zone having pointer information on the BCA area.

32. The storage medium of claim 31, further comprising a rewritable area which is provided in at least one of the lead-in and lead-out areas to reproduce user data of the storage medium.

33. The storage medium of claim 31, wherein the BCA pointer zone is provided in each of the recording layers.
